(19) United States
(12) Patent Application Publication
(10) Pub. No.: US 2026/0277964 A1
(43) Pub. Date: Sep. 17, 2026

(54) SYSTEMS AND METHODS FOR LOG ANALYSIS USING LARGE LANGUAGE MODELS AND QUANTUM COMPUTATIONAL TECHNIQUES

(71) Applicant: JPMORGAN CHASE BANK, N.A., New York, NY (US)

(72) Inventor: Sanjay GOEL, Princeton, NJ (US)

(21) Appl. No.: 19/566,349

(22) Filed: Mar. 13, 2026

Related U.S. Application Data
(60) Provisional application No. 63/771,946, filed on Mar. 14, 2025.

(51) Int. Cl. G06F 16/3332; G06F 16/358

(52) U.S. Cl. CPC G06F 16/3335; G06F 16/358

(57) ABSTRACT

Embodiments may provide a quantum-assisted system for analyzing log data and clustering errors based on frequency and semantic similarity. The system processes log data from CSV files, vectorizes error messages using SpaCy, stores embeddings in Chroma Database (optional), and applies quantum computation to optimize clustering with centroids. By identifying the top errors within each cluster, the system offers advanced insights for troubleshooting. An orchestration subsystem may automatically execute an action determined based on the advanced insights in the target environment.

### BACKGROUND OF THE INVENTION

### 1. Field of the Invention

Embodiments relate to systems and methods for log analysis using large language models and quantum computational techniques.

### 2. Description of the Related Art

Modern computing environments generate large volumes of operational data in the form of system logs, application logs, network logs, and security logs. Such log data may be produced continuously by distributed services, containers, virtual machines, and endpoint devices, and may contain information indicative of performance degradation, configuration errors, resource exhaustion, authentication failures, and other anomalous events. In many deployments, log messages are primarily unstructured or semi-structured text, and the vocabulary, formatting, and semantics of the messages may vary significantly across components and over time.

The scale and heterogeneity of log data can hinder manual review and can delay identification of recurring faults and root causes. Conventional approaches often rely on keyword searches, regular-expression rules, fixed parsing templates, or manually curated taxonomies. While such techniques can be effective for known patterns, they may be costly to maintain, may not generalize across changing software versions or environments, and may fail to group semantically similar log messages that use different wording.

Machine learning techniques, including unsupervised clustering, have been applied to group similar log entries and to highlight frequent error modes. However, the effectiveness of clustering is highly dependent on the quality of text preprocessing and feature extraction. In addition, clustering methods such as K-means can be sensitive to initialization of centroids and may converge to suboptimal solutions, produce inconsistent results across runs, or require multiple initializations to obtain stable clusters, thereby increasing computational cost when processing large datasets.

Natural language processing (NLP) methods can assist in transforming unstructured log text into representations suitable for clustering and analysis. More recently, large language models and other advanced NLP pipelines have been used to improve tokenization, normalization, entity recognition, and vectorization of text. Despite these advances, the integration of language-model-based processing into operational, security-critical, or reliability-critical workflows presents challenges, including robustness and repeatability of outputs. In particular, some generative language-model techniques may produce hallucinated or non-verifiable content, which is undesirable for automated troubleshooting and for workflows that require traceability to the original log evidence.

In view of the foregoing, there remains a need for improved systems and methods that can analyze log data at scale, transform unstructured log text into reliable machine-usable features, and efficiently cluster related errors in a manner that is repeatable and computationally efficient. There is also a need for techniques that improve clustering performance by addressing sensitivity to centroid initialization while maintaining fidelity to the underlying log data.

### SUMMARY

Embodiments may integrate space Cython (“spaCy's”) natural language processing (NLP) capabilities executed by one or more processors with quantum computation executed by a quantum computer to analyze and cluster log data efficiently. Embodiments may transform unstructured logs into meaningful insights by leveraging advanced NLP for preprocessing and quantum methods for optimizing clustering.

Disclosed embodiments may include a computer-implemented technique for converting raw, unstructured machine log text into actionable, clustered error insights using a combination of (i) a SpaCy large language model (LLM) natural language processing pipeline for text preparation and representation and (ii) quantum-derived randomness to improve or diversify clustering initialization. Disclosed embodiments may include log entries that are ingested from one or more computing resources (for example, servers or applications). The log entries may be preprocessed using a SpaCy LLM-based pipeline to produce normalized text suitable for downstream analytics. The preprocessing may expressly include tokenization, named entity recognition, and/or removal of stop-words, thereby structuring the log content and reducing noise.

The normalized log text may be converted into numerical representations as feature vectors. In certain embodiments, this vectorization may be performed using term frequency-inverse document frequency (TF-IDF), and the resulting vectors may optionally be stored in and retrieved from a vector database to support scalable processing. A quantum-derived random value may be generated by executing a quantum circuit on either a quantum computer or a quantum computer simulator. In an example implementation, the circuit applies a Hadamard gate to create superposition and then measures the qubit to obtain a random bit. This quantum-derived randomness may be used during centroid initialization for an unsupervised clustering algorithm: centroids are initially selected using random indices and then adjusted based on the quantum-derived random value (for example, by incrementing or decrementing an index). Modulo arithmetic may be applied to keep adjusted indices within valid dataset bounds, and uniqueness checks may be enforced so that the initialized centroids correspond to distinct data points. Using these quantum-influenced initial centroids, the feature vectors may be clustered into groups (e.g., via K-means). Disclosed methods may include generating cluster-level results, including a cluster summary that is based on the set of log entries assigned to a cluster, and/or outputting analysis artifacts such as a table identifying frequent errors per cluster and/or a visualization showing cluster membership or cluster distribution. In some embodiments, the number of clusters may be determined based on one or more characteristics of the ingested log entries, and K-means clustering may be performed using that determined number of clusters.

Embodiments may provide at least some of the following: (1) Enhanced Log Analysis: Efficiently identifies and clusters frequent errors; (2) Improved Troubleshooting: Groups similar errors, enabling faster root-cause analysis; (3) Scalability: Handles large-scale log data using quantum and classical method; (4) Reduced Downtime: Proactively detects recurring issues, minimizing disruptions; (5) Cost Efficiency: Streamlines error analysis, reducing operational expenses; and (6) Actionable Insights: Provides a clear view of error trends within clusters for targeted resolution.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a diagram of a system for log analysis using spacy large language models and quantum computational techniques, in accordance with embodiments.

FIG. 2 is a method for log analysis using spacy large language models and quantum computational techniques, in accordance with embodiments.

FIG. 3 is a code for log analysis using spacy large language models and quantum computational techniques, in accordance with embodiments.

FIG. 4 is an output table of clusters versus data points, in accordance with embodiments.

FIG. 5 is a diagram of a computing device for implementing certain embodiments of the present disclosure.

### DETAILED DESCRIPTION

Systems and methods for log analysis using spacy large language models and quantum computational techniques are disclosed.

Embodiments provide systems and methods for computer-implemented log data analysis. According to one embodiment, a method may include ingesting, by an application executed by one or more processors, log entries comprising unstructured text from one or more computing resources; preprocessing, by the application in communication with a natural language processing pipeline that includes a spaCy large language model, the log entries to generate normalized text, wherein preprocessing comprises tokenizing the log entries, performing named entity recognition, and removing stop-words; vectorizing, by the application, the normalized text to generate feature vectors representing respective ones of the log entries; generating, by the one or more processors, a quantum-derived random value by executing a quantum circuit on a quantum computer or a quantum computer simulator; initializing, by the application, a plurality of centroids for clustering based on (i) randomly selected log-entry indices and (ii) an adjustment to at least one of the randomly selected log-entry indices responsive to the quantum-derived random value; clustering, by the application, the feature vectors into clusters using an unsupervised clustering algorithm that uses the plurality of centroids as initial centroids; generating, by the application, a cluster summary for at least one cluster based on log entries assigned to the at least one cluster; and outputting, by the application, at least one of (i) a table identifying a plurality of frequent errors within the clusters and/or (ii) a visualization of cluster membership.

According to one embodiment, the method may further comprise applying, by the application, term frequency-inverse document frequency (TF-IDF) to the normalized text to perform the vectorizing.

According to one embodiment, the method may further comprise storing, by the application in communication with a database, the feature vectors in a vector database prior to clustering, and retrieving, by the application, the feature vectors from the vector database for performing the clustering.

According to one embodiment, generating the quantum-derived random value may comprise executing, by the one or more processors, a quantum circuit that applies a Hadamard gate to a qubit and measures the qubit to produce a measurement result used as a random bit.

According to one embodiment, initializing the plurality of centroids may comprise applying, by the application, modulo arithmetic to constrain an adjusted log-entry index to an index range of an available set of feature vectors.

According to one embodiment, initializing the plurality of centroids may involve ensuring that centroid indices are distinct by rejecting a candidate index that matches a previously selected centroid index and selecting a replacement index.

In some embodiments, the method may further comprise determining, by the application, a number of clusters based on at least one characteristic of the log entries, and clustering may comprise performing, by the application, K-means clustering using the determined number of clusters.

Enhanced log analysis may efficiently identify and cluster frequent errors. Improved troubleshooting can group similar errors, enabling faster root-cause analysis. Scalability may allow handling of large-scale log data using quantum and classical methods. Reduced downtime can proactively detect recurring issues, minimizing disruptions. Cost efficiency may streamline error analysis, reducing operational expenses. Actionable insights can provide a clear view of error trends within clusters for targeted resolution.

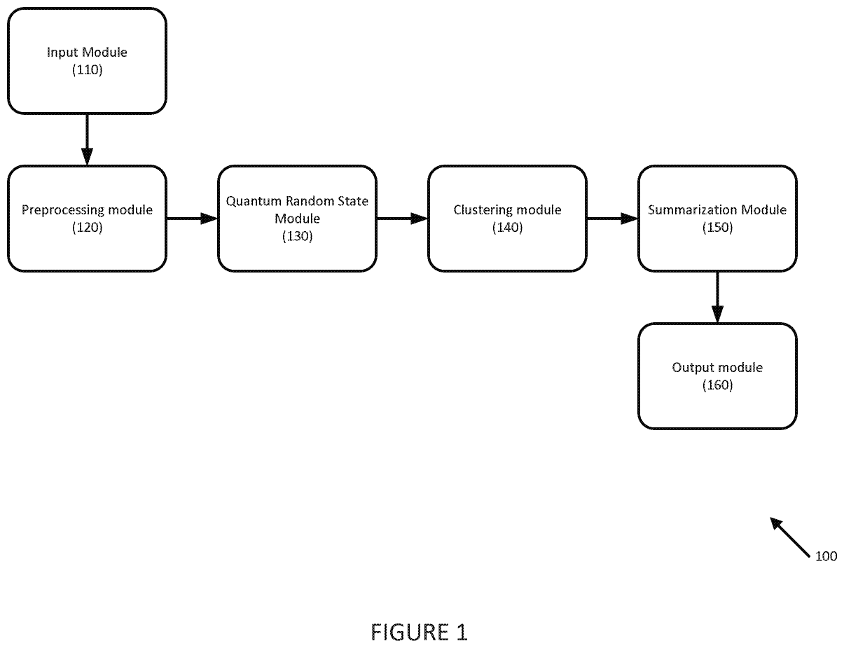

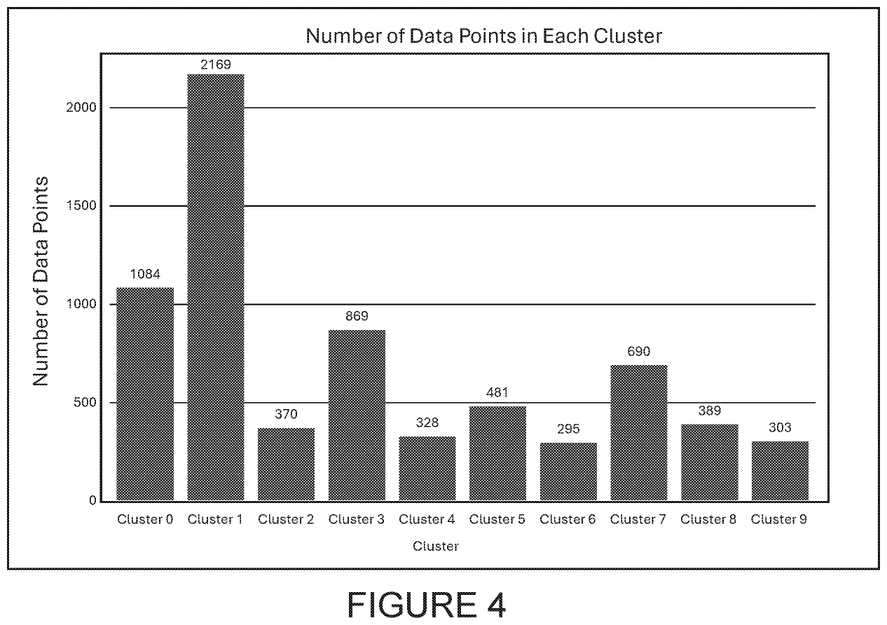

Referring to FIG. 1, a system for log analysis using spacy large language models and quantum computational techniques are disclosed according to an embodiment. System 100 may include input module 110 that accepts raw log data from servers or applications, preprocessing module 120 that uses spaCy LLM for tokenization, named entity recognition (NER), and vectorization, quantum random state module 130 that generates quantum random states for centroid initialization using a quantum computer, or a quantum computer simulator. System 100 may include clustering module 140 that groups log data into clusters (e.g., shown in FIG. 4) using K-Means unsupervised clustering algorithm. System 100 may include summarization module 150 that summarizes clustered logs using spaCy for human-readable insights. System 100 may include output module 160 that displays results as tables and visualizations.

In some embodiments, the system 100 may include a fully autonomous, continuous error-fixing system in which the system 100 itself applies corrective actions without involvement of human operators. In such embodiments, the log-analysis pipeline that leverages spaCy-based natural language processing and quantum-assisted clustering may operate as an analytic engine within a closed-loop control architecture that continuously observes log streams, identifies error patterns, selects remediation actions, and/or verifies outcomes.

In one embodiment, input module 110 may comprise an ingestion and monitoring subsystem that may continuously receive streaming log entries from production systems, including application servers, databases, microservices, network devices, and/or container orchestration platforms. The ingestion subsystem may normalize timestamps and attach contextual metadata, such as host identifiers, service names, deployment versions, and/or geographic regions, and may forward the raw log content to preprocessing module 120. Preprocessing module 120 may apply the spaCy natural language processing pipeline (e.g., a list of instructions among one or more programs stored on one or more memory accessible by system 100) to each incoming log entry and/or to micro-batches of log entries, thereby generating normalized text and corresponding feature vectors in near real time.

The feature vectors produced from the streaming log entries may be stored in a vector database or an in-memory store, and may be clustered on a periodic or streaming basis using the quantum-assisted centroid initialization and unsupervised clustering described herein. For example, system 100 may perform clustering over sliding time windows, such as the last N minutes of logs, with incremental updates as new data arrives. The use of quantum-derived random values for centroid initialization may help the system maintain robust cluster formation as the distribution of log messages drifts over time, reducing sensitivity to local minima and initialization bias.

Following clustering for a given time window, summarization module 150 may generate cluster-level artifacts, including human-readable descriptions of each cluster and structured metrics such as error frequency, growth rate, and estimated severity. The severity of a cluster may be computed automatically based on one or more attributes, including service criticality, occurrence rate, the presence of known high-risk keywords, historical correlations with service-level objective violations, and/or anomaly scores computed over cluster-level statistics. The system may thereby generate, without human intervention, a ranked set of active clusters prioritized by their calculated impact on the environment.

Output module 160 may include a fully automated decision engine that may consume the cluster summaries and associated metrics and select one or more remediation actions to be executed for each cluster that exceeds an automatically determined action threshold. The decision engine may rely on a machine-readable knowledge base, in communication or stored in a memory of system 100, that encodes mappings from cluster signatures to remediation actions. A cluster signature may include attributes such as the cluster summary text, representative error messages, affected components, and/or contextual metadata. For example, when a cluster signature indicates repeated disk-space exhaustion errors on a particular node or volume, the decision engine may select a remediation action that automatically expands the storage allocation, purges transient files, compresses archival logs, and/or reconfigures log rotation policies.

The knowledge base may be represented as a rules engine, a learned policy model, or a hybrid of both. In a rules-based configuration, the knowledge base may specify explicit conditions over cluster attributes and corresponding actions, such as “if cluster summary contains ‘connection timeout’ and affected service is a stateless microservice, then restart the service and update connection pool parameters.” In a learned configuration, the decision engine may use reinforcement learning or supervised models trained on historical cluster-remediation-outcome data to select actions that previously resulted in successful resolution.

In some embodiments, once the clustered log data has been analyzed and the top errors within a cluster have been identified, the system may initiate one or more remediation actions responsive to the error type associated with the cluster. The remediation action may be selected based on keywords, entities, cluster summaries, log frequencies, or combinations thereof. In this manner, the disclosed system may not only identify recurring issues in log data, but may also support corrective actions directed to the underlying operational condition reflected by the clustered logs.

In one embodiment, when a cluster is associated with a storage-related issue, such as a disk space issue, disk capacity warning, log-file growth condition, or file-system utilization threshold, the remediation action may include deleting temporary files, archiving or compressing log files, rotating log files, increasing available storage allocation, and/or generating a maintenance task for a storage administrator. For example, where clustered logs indicate a disk space issue on a drive, the system may identify that recurring error pattern and output a recommended or automated storage cleanup action corresponding to that cluster with the disk space issue.

In another embodiment, when a cluster is associated with a network-related issue, such as a timeout, dropped connection, unreachable endpoint, or degraded communications between servers, the remediation action may include restarting a network service, retrying a failed connection, rerouting traffic to an alternate endpoint, increasing a timeout value, resetting a session, and/or generating an alert identifying the affected server or application. For example, where clustered logs indicate a network timeout issue affecting one or more servers, the system may associate that cluster with a communications remediation workflow and output a corresponding corrective action.

In a further embodiment, when a cluster is associated with a configuration-related issue, such as a disk configuration error, server configuration mismatch, application programming interface call failure, and/or invalid parameter setting, the remediation action may include restoring a prior configuration, applying a configuration update, validating a configuration file against a known schema, restarting a service after configuration correction, and/or routing the identified issue to a configuration management system. In this manner, recurring configuration-related log messages may be grouped into a common cluster and linked to one or more corrective actions intended to reduce repeated failures arising from misconfiguration.

In some embodiments, the remediation action may be performed automatically by the application and/or may be output as a recommendation for review by a user, administrator, or external orchestration system. For example, the output module 160 may display a table in which each cluster is associated with a corresponding recommended action, an error frequency, and an affected system component. In another embodiment, the output may include a machine-readable instruction or event that is transmitted to an external ticketing platform, workflow engine, monitoring platform, or infrastructure management tool for execution of the remediation action.

In some embodiments, remediation actions may be prioritized based on a severity metric associated with a cluster. The severity metric may be based on the number of log entries assigned to the cluster, a rate of occurrence of the clustered error, an affected resource identified through named entity recognition, or whether the cluster corresponds to a previously observed error pattern. Clusters having a higher frequency or affecting critical computing resources may be assigned a higher remediation priority, thereby enabling the system to direct corrective resources to the errors most likely to affect system performance or availability.

In further embodiments, the system may store an association between a cluster pattern and a successful remediation action for subsequent use. When a later set of ingested log entries produces a cluster having a similar vector profile, summary, or error signature, the system may retrieve the previously associated remediation action and output that action as a recommended response. In this manner, the disclosed system may support repeated troubleshooting operations by correlating clustered error patterns with past corrective measures.

In still further embodiments, the system may verify whether a remediation action corresponds to a reduction in the frequency of an identified error cluster. For example, after a corrective action is performed, newly ingested log entries may be preprocessed, vectorized, and reclustered to determine whether the relevant error pattern has decreased, remained unchanged, or increased. This feedback may be used to update the remediation recommendation associated with that cluster, thereby improving future targeted resolution of recurring log-based errors.

Once a remediation action is selected, output module 160 may comprise an orchestration subsystem that may automatically execute the action in the target environment. The orchestration subsystem may interface with infrastructure-as-code systems, container orchestrators, configuration management tools, and/or cloud provider application programming interfaces (“APIs”) to perform operations such as restarting services and/or pods, scaling instances up or down, adjusting resource quotas, rolling back to earlier software versions, applying configuration patches, and/or modifying network (e.g., comprising several computers in communication) and firewall rules. The orchestration subsystem may implement safety mechanisms such as rate limits, blast-radius restrictions, and/or staged rollouts to prevent uncontrolled propagation of changes.

Output module 160 may comprise a verification module that may operate continuously to evaluate the effect of each executed remediation action. After an action is applied, the verification module may monitor subsequent log streams and relevant performance indicators over a post-remediation evaluation window. The module may reapply the clustering and summarization pipeline to the post-remediation logs, and/or compare the frequency and severity of the targeted error cluster before and after the remediation. If the error cluster frequency drops below a defined threshold or disappears, the verification module may automatically mark the remediation as successful and update the knowledge base to reinforce the effectiveness of the selected action.

If the verification module determines that a remediation was not successful, for example, when the error cluster persists, increases in frequency, or spawns a related cluster, the system may automatically select an alternative remediation action from the knowledge base. The decision engine may use feedback from unsuccessful attempts to avoid repeating ineffective actions and may adjust its internal policy to reduce the likelihood of selecting actions that historically failed for similar cluster signatures. In certain embodiments, the system may also revert or roll back previously applied configuration changes when verification indicates that an action degraded overall system stability.

Over time, the closed-loop interaction through the decision engine, the orchestration subsystem, and the verification module may allow the system to autonomously refine its remediation strategies. The clustering and summarization components provide structured representations of evolving error patterns, while the decision engine and verification module incrementally improve the mapping between cluster types and corrective actions based on observed outcomes. This feedback-driven adaptation may enhance the system's ability to mitigate recurring faults, handle emerging error types, and/or maintain service reliability without human supervision.

In some embodiments, the fully automated error-fixing system of system 100 may maintain an internal audit trail describing detected clusters, selected remediation actions, execution details, and/or verification results. These records may be stored for compliance, forensic analysis, and/or offline model training. The system may also expose machine-readable status indicators, such as health scores or stability metrics, that can be consumed by external monitoring tools or higher-level orchestration layers, even though no human operator is required for normal remediation workflows.

By integrating spaCy-based language processing with quantum-assisted clustering, and coupling these analytics with autonomous decision and orchestration components, the disclosed embodiments may provide a continuous and fully automated error-fixing system capable of transforming raw, unstructured log data into self-initiated corrective actions. This may reduce or eliminate the need for human-led triage and remediation, decrease mean time to detection and resolution, and increase the resilience and self-healing capabilities of complex, distributed computing environments.

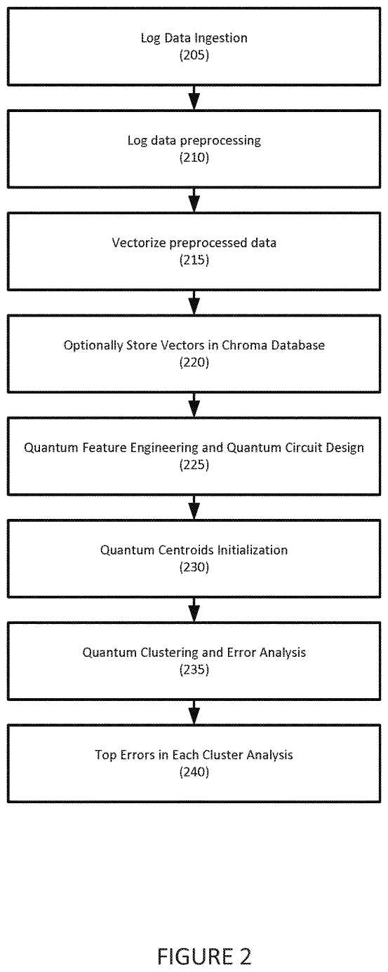

Referring to FIG. 2, a method for log analysis using spaCy large language models and quantum computational techniques are disclosed according to an embodiment.

In step 205, log data may be ingested. Examples of log data sources include system logs, application logs, or server logs. The log data may be in simple text format as comma separated value (CSV) files.

An example of code to ingest log data is as follows:
vbnet
Copy code
Diskspace issue on D drive
Network timeout issue on servers A
Diskconfiguration error calling best success solutions (“BSS”)
/API Call or serverconfig

As presented, the code example consists of sample log or error text entries. The listed entries include “Diskspace issue on D drive,” “Network timeout issue on servers A,” and “Diskconfiguration error calling BSS/API Call or serverconfig.” The code may illustrate input log messages that may be ingested by the system for subsequent analysis, clustering, and/or error processing.

In step 210, the log data may be preprocessed. For example, the log data may be tokenized, may undergo named entity recognition (NER), and may have stop-words removed. In one embodiment, a LLM, such as spaCy LLM, may be used.

The result of the preprocessing is a cleaned and structured data that is ready for vectorization.

Example code for preprocessing the log files is as follows:

```
import spacy
from sklearn.feature_extraction.text import TfidfVectorizer
nlp = spacy.load(″en_core_web_sm″)
# Preprocess text
def preprocess_logs(log_lines):
  processed = [ ]
  for line in log_lines:
    doc = nlp(line)
    tokens = [token.lemma_ for token in doc if not token.is_stop
and token.is_alpha]
    processed.append(“ ”.join(tokens))
  return processed
```

The code describes preprocessing code that prepares log text for later analysis using SpaCy. The code imports SpaCy and TfidfVectorizer, loads the English SpaCy language model, and defines a preprocess_logs(log_lines) function. TfidfVectorizer may be a software tool imported from sklearn. feature_extraction. text in the preprocessing example. In context, it is included alongside the SpaCy preprocessing pipeline, so it may convert processed log text into a form suitable for later analysis, such as feature extraction and/or clustering. The function may iterate through each log line, may process the line with the SpaCy model, may extract token lemmas while filtering out stop words and/or non-alphabetic tokens, may join the remaining tokens into a normalized string, and may append the result to a processed list, which is then returned. In substance, the code converts raw log entries into cleaned, normalized textual representations suitable for subsequent feature extraction and/or clustering.

In step 215, the preprocessed data may be vectorized. In one embodiment, Term Frequency-Inverse Document Frequency (TF-IDF) may be used to convert the text logs into numerical vectors for clustering. Once vectorized, in step 220, the vector data may optionally be stored in a database, such as a Chroma database in a programming language such as python.

In step 225, quantum feature engineering and quantum circuit design may be performed. In one embodiment, this may include quantum random state generation. This function demonstrates a basic use of quantum computing to generate randomness, which is a fundamental aspect of quantum mechanics.

An example of code is as follows:

```
from qiskit import QuantumCircuit, transpile
from qiskit_aer import Aer
def quantum_random_state( ):
  circuit = QuantumCircuit(1, 1)
  circuit.h(0) # Create superposition
  circuit.measure(0, 0)
  simulator = Aer.get_backend(‘qasm_simulator’)
  transpiled_circuit = transpile(circuit, simulator)
  job = simulator.run(transpiled_circuit, shots=1)
  result = job.result( )
  counts = result.get_counts( )
  return ‘1’ if counts.get(‘1’, 0) > 0 else ‘0’
```

The code may define a quantum_random_state( ) function using Qiskit. In that code, a quantum circuit having one qubit and one classical bit is created, a Hadamard operation is applied to qubit 0 to create superposition, and the qubit is then measured into classical bit 0. The code next obtains a qasm_simulator backend from Aer, transpiles the circuit for that simulator, runs the circuit for a single shot, obtains the result, reads the measurement counts, and returns ‘1’ if the measured outcome includes 1, or otherwise returns ‘0’. Based on the paragraph, the code may generate a single binary output from a quantum-circuit measurement.

This code defines a function quantum_random_state that generates a random bit using a quantum circuit. Portions of the code may include:

QuantumCircuit(1, 1): This creates a quantum circuit with one qubit and one classical bit. The qubit is used for quantum operations, and the classical bit is used to store the measurement result.
circuit. h(0): This applies a Hadamard gate to the qubit at index 0. The Hadamard gate puts the qubit into a superposition state, meaning it has an equal probability of being measured as 0 or 1.
circuit.measure(0, 0): This measures the qubit and stores the result in the classical bit. The measurement collapses the qubit's superposition to either 0 or 1.

AerSimulator( ): This creates a simulator for running the quantum circuit. The AerSimulator is part of Qiskit, a quantum computing framework, and it simulates the behavior of a quantum computer.
transpile(circuit, simulator): This function optimizes the quantum circuit for the specific simulator. Transpilation involves converting the circuit into a form that can be executed on the simulator.
simulator.run(transpiled_circuit, shots=1): This runs the transpiled circuit on the simulator. The shots=1 parameter specifies that the circuit should be executed 1024 times to gather statistics on the measurement outcomes. result. get_counts( ): This retrieves the counts of measurement outcomes from the simulation. It returns a dictionary where the keys are the measurement results (‘0’ or ‘1’) and the values are the number of times each result was observed.
return ‘1’ if counts. get(‘1’, 0)>0 else ‘0’: This checks if there were any occurrences of the measurement result ‘1’. If so, it returns ‘1’; otherwise, it returns ‘0’. This effectively generates a random bit based on the quantum measurement.

The function quantum_random_state may generate a random bit, which is printed to the console. The randomness comes from the inherent probabilistic nature of quantum mechanics, as the Hadamard gate creates a superposition that is randomly collapsed upon measurement.

In step 230, quantum centroids may be initiated. In one embodiment, quantum randomness may be used. The quantum_random_state( ) function may introduce an element of quantum randomness in adjusting the initial random index, which can add variability to the initialization process.

Next, modulo arithmetic may be used to ensure that the index adjustments wrap around the dataset boundaries, preventing out-of-bounds errors.

Each centroid may be initialized with a unique data point by checking against previously used indices.

An example of code for this step is as follows:

```
def quantum_initialize_centroids(X, num_clusters):
  centroids = [ ]
  indices = [ ]
  for _ in range(num_clusters):
    random_idx = np.random.randint(0, X.shape[0])
    # Use quantum randomness to adjust the random index
    #The quantum_random_state( ) function is called to get a
quantum random bit. If the bit is ‘1’,
    # the index is incremented; if ‘0’, it is decremented.
Modulo arithmetic ensures the index stays within bounds.
    quantum_bit = quantum_random_state( )
    if quantum_bit == ‘1’:
      random_idx = (random_idx + 1) % X.shape[0] #
Increment index
    else:
      random_idx = (random_idx − 1) % X.shape[0] #
Decrement index
    while random_idx in indices:
      random_idx = np.random.randint(0, X.shape[0])
      quantum_bit = quantum_random_state( )
      if quantum_bit == ‘1’:
        random_idx = (random_idx + 1) % X.shape[0]
      else:
        random_idx = (random_idx − 1) % X.shape[0]
    indices.append(random_idx)
    centroids.append(X[random_idx].toarray( )[0])
  return np.array(centroids)
```

The code may include a quantum_initialize_centroids(X, num_clusters) function that initializes cluster centroids by selecting data points from, for example, XX. The code creates centroids and indices lists, then repeatedly chooses a random index for each cluster. The function may call quantum_random_state( ) to obtain a quantum random bit and uses that bit to adjust the selected index: if the bit is ‘1’, the index is incremented modulo the number of rows in XX; otherwise, the index is decremented modulo the number of rows. The code may check whether the adjusted index has already been used, and if so, it repeats the random selection and quantum-based adjustment until an unused index is found. The selected index may be added to the indices list, and the corresponding data point from XX is appended to the centroids list. The code may randomly select centroids, together with a quantum-derived bit to influence centroid initialization, while avoiding duplicate centroid choices.

This function, quantum_initialize_centroids, may initialize centroids for a clustering algorithm, such as k-means, using a dataset X. The function may include:

Parameters: (1) X: This is the dataset from which centroids are to be initialized. It is assumed to be a 2D array-like structure, such as a numerical python (“NumPy”) array or a sparse matrix; (2) num_clusters: This is the number of clusters (or centroids) you want to initialize.

Variables: (1) centroids: This list will store the initialized centroids; (2) indices: This list keeps track of the indices of the data points that have been selected as centroids to avoid duplicates.

Loop for Initialization: (1) The loop runs num_clusters times to select that many centroids; (2) np.random.randint(0, X.shape[0]): This generates a random index within the range of the dataset's number of samples (rows). X.shape[0] gives the number of samples in X; (3) while random_idx in indices: This loop ensures that the same index is not selected more than once. If a duplicate index is generated, it continues to generate a new random index until a unique one is found; (4) indices. append(random_idx): Once a unique index is found, it is added to the indices list to keep track of selected indices.

Extracting Centroids: (1) X[random_idx].toarray( )[0]: This extracts the data point at the randomly selected index. If X is a sparse matrix, toarray( ) converts it to a dense array, and [0] accesses the first (and only) row of the resulting 2D array; (2) centroids. append( . . . ): The extracted data point is added to the centroids list.

Return Statement: return np.array(centroids): The list of centroids is converted to a NumPy array and returned. This array contains the initialized centroids for the clustering algorithm.

Overall, this function randomly selects num_clusters unique data points from the dataset X to serve as initial centroids for a clustering algorithm. The use of random selection helps in providing a diverse starting point for the clustering process.

In step 235, quantum clustering and error analysis may be performed. Quantum centroids refer to the concept of using quantum computing principles to enhance the process of finding centroids in clustering algorithms, such as K-means clustering. Clustering is a common unsupervised machine learning technique used to group similar data points together. The centroid of a cluster is the point that represents the center of that cluster.

The proper initialization of centroids may help avoid errors (e.g., better data analysis) and improve the quality and consistency of the clustering results.

Visualization of data may be done after the K-means clustering is completed for the data.

Example code to cluster is as follows:

# Set the number of clusters
num_clusters = determine_number_of_clusters(log_lines)
num_clusters
# Initialize centroids
initial_centroids = quantum_initialize_centroids(X, num_clusters)
# Corrected KMeans implementation
kmeans = KMeans(n_clusters=num_clusters, init=initial_centroids,
n_init=1)
kmeans.fit(X)

The kmeans.fit(X) method may apply k-means clustering to a dataset. Applying kmeans.fit(X) may include initializing centroids, iteratively assigning data points to clusters, updating centroids, and/or converging to a stable clustering solution. The results of this process provide insights into the structure of the data and may be used for further analysis and/or decision-making as described herein, particularly in reference to FIG. 1.

In step 240, the top errors in each cluster analysis may be returned. In one embodiment, once the clustering of data is completed, the clustering may be converted into human readable format using a function, such as the prettytable Phyton function. The data in different clusters may be summed up and sorted out. The sum of all data in each cluster may provide the total number of errors. The sorted data lines in each cluster may provide the top errors in each cluster (based upon the sum of number of lines for each error).

Example code for this function is as follows:

```
def summarize_clusters(clusters, log_lines):
  summaries = { }
  for cluster_id, indices in clusters.items( ):
    logs = [log_lines[i] for i in indices]
    summary = nlp(“ ”.join(logs))._.coref_resolved # Example
summarization
    summaries[cluster_id] = summary
  return summaries
```

This code may include a summarize_clusters(clusters, log_lines) function. The function may create a summaries dictionary and may iterate through each cluster_id and its corresponding indices in the clusters mapping. For each cluster, the function may collect the associated log entries from log_lines, may join those logs into a single text string, processes that string with nlp(. . . ), and may use the coref_resolved output as an example summary. The resulting summary may be stored in the summaries dictionary under the corresponding cluster identifier, and the function may return the completed dictionary. In substance, the code may generate a summary for each cluster based on the log lines assigned to that cluster.

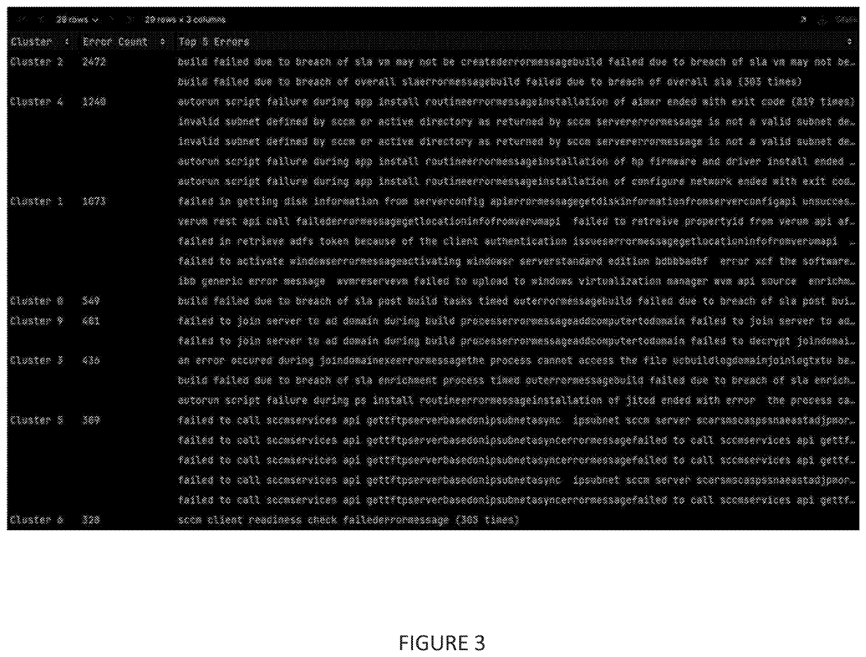

FIG. 3 is a table illustrating an example output of a log-analysis system after clustering of log entries. In the example shown, the table includes, for each cluster identifier, an error count corresponding to a number of log entries assigned to the cluster, and representative top error strings for the cluster. The representative top error strings may be determined by aggregating identical or substantially similar log messages within the cluster and ranking the aggregated messages according to frequency. The table of FIG. 3 may be presented via a graphical user interface to enable an operator to quickly identify predominant error modes associated with respective clusters.

FIG. 4 is a bar graph illustrating an example distribution of clustered log entries across multiple clusters. In the example shown, a horizontal axis identifies cluster identifiers and a vertical axis indicates a number of data points assigned to each cluster. Each bar represents a respective cluster and has a height proportional to the number of log entries mapped to the cluster by an unsupervised clustering algorithm. The visualization of FIG. 4 may be used to identify high-volume clusters, outlier clusters, and/or trends indicative of recurring issues within a computing environment.

Hereinafter, general aspects of implementation of the systems and methods of embodiments will be described.

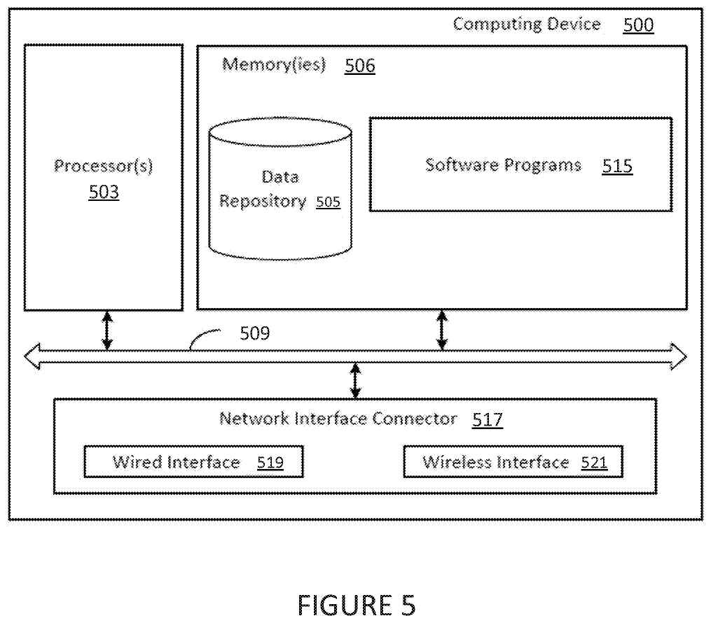

FIG. 5 is a diagram of a computing device for implementing certain embodiments of the present disclosure. FIG. 5 depicts exemplary computing device 500. Computing device 500 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 500.

Computing device 500 includes a processor 503 coupled to a memory 506. Memory 506 may include volatile memory and/or persistent memory. The processor 503 executes computer-executable program code stored in memory 506, such as software programs 515. Software programs 515 may include one or more of the logical steps disclosed herein as a programmatic instruction, which can be executed by processor 503. Memory 506 may include data repository 505, which may be nonvolatile memory for data persistence. The processor 503 and the memory 506 may be coupled by a bus 509. In some examples, the bus 509 may be coupled to one or more network interface connectors 517, such as wired network interface 519, and/or wireless network interface 521. Computing device 500 may have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular layer, pathway, step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other system, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialog screen for example. A user interface may also include any of a mouse, touch screen, keyboard, keypad, voice reader, voice recognizer, dialog screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, embodiments, adaptations, variations, modifications, or equivalent arrangements.

1. A computer-implemented method for analyzing log data, the method comprising:
ingesting, by an application executed by one or more processors, log entries comprising unstructured text from one or more computing resources;
preprocessing, by the application in communication with a natural language processing pipeline that includes a spaCy large language model, the log entries to generate normalized text, wherein preprocessing comprises tokenizing the log entries, performing named entity recognition, and removing stop-words;
vectorizing, by the application, the normalized text to generate feature vectors representing respective ones of the log entries;
generating, by the one or more processors, a quantum-derived random value by executing a quantum circuit on a quantum computer or a quantum computer simulator;
initializing, by the application, a plurality of centroids for clustering based on (i) randomly selected log-entry indices and (ii) an adjustment to at least one of the randomly selected log-entry indices responsive to the quantum-derived random value;
clustering, by the application, the feature vectors into clusters using an unsupervised clustering algorithm that uses the plurality of centroids as initial centroids;
generating, by the application, a cluster summary for at least one cluster based on log entries assigned to the at least one cluster; and
outputting, by the application, at least one of (i) a table identifying a plurality of frequent errors within the clusters or (ii) a visualization of cluster membership.

2. The method of claim 1, wherein vectorizing comprises applying term frequency-inverse document frequency (TF-IDF) to the normalized text.

3. The method of claim 1, further comprising storing, by the application in communication with a database, the feature vectors in a vector database prior to clustering, and retrieving the feature vectors from the vector database for performing the clustering.

4. The method of claim 1, wherein generating the quantum-derived random value comprises executing a quantum circuit that applies a Hadamard gate to a qubit and measures the qubit to produce a measurement result used as a random bit.

5. The method of claim 1, wherein initializing the plurality of centroids comprises applying modulo arithmetic to constrain an adjusted log-entry index to an index range of an available set of feature vectors.

6. The method of claim 1, wherein initializing the plurality of centroids comprises enforcing uniqueness of centroid indices by rejecting a candidate index that matches a previously selected centroid index and selecting a replacement index.

7. The method of claim 1, further comprising determining a number of clusters based on at least one characteristic of the log entries, and wherein clustering comprises performing K-means clustering using the determined number of clusters.

8. A system for analyzing log data, comprising:
one or more processors; and
one or more non-transitory storage devices storing instructions that, when executed by the one or more processors, cause the system to:
ingest log entries comprising unstructured text; preprocess the log entries using a natural language processing pipeline that includes a spaCy large language model to generate normalized text, wherein preprocessing comprises tokenization, named entity recognition, and stop-word removal;
vectorize the normalized text to generate feature vectors;
obtain a quantum-derived random value by executing a quantum circuit on a quantum computer or a quantum computer simulator;
initialize centroids for clustering based on randomly selected indices and an adjustment responsive to the quantum-derived random value;
cluster the feature vectors into clusters using an unsupervised clustering algorithm initialized with the centroids; and
generate a summary for at least one cluster based on log entries assigned to the at least one cluster; and provide an output comprising at least one of (i) a table of frequent errors by cluster or (ii) a visualization of clusters.

9. The system of claim 8, wherein the instructions further cause the system to determine a number of clusters as a function of at least one of a log volume, a vocabulary size of the normalized text, or a distribution of similarity scores among the feature vectors.

10. The system of claim 8, wherein the instructions further cause the system to store the feature vectors in a database and subsequently retrieve the feature vectors for performing the clustering.

11. The system of claim 8, wherein the instructions cause the system to obtain the quantum-derived random value by executing the quantum circuit on a quantum processing unit, and wherein the quantum processing unit is accessed via an application programming interface.

12. The system of claim 8, wherein the instructions cause the system to obtain the quantum-derived random value by executing the quantum circuit on a quantum computer simulator operating on a classical processor.

13. The system of claim 8, wherein the output comprises, for each respective cluster, a ranked list of log-entry strings corresponding to a top-N frequency of repeated errors within the each respective cluster.

14. The system of claim 8, wherein generating the summary comprises generating a human-readable description of a cluster based on concatenated log entries assigned to the cluster and processing the concatenated log entries with the natural language processing pipeline.

15. A non-transitory computer-readable medium storing instructions that, when executed by one or more processors, cause a computing system to perform operations comprising:
receiving log entries comprising unstructured text; preprocessing the log entries using a natural language processing pipeline that includes a spaCy large language model to generate normalized text; generating feature vectors from the normalized text;
generating a quantum-derived random value by executing a quantum circuit using a quantum computer or a quantum computer simulator;
initializing clustering centroids based on a random selection of feature-vector indices and a quantum-driven adjustment to at least one selected index;
clustering the feature vectors into clusters using the initialized clustering centroids; and
producing cluster-level outputs that include at least one of (i) a summary of a cluster or (ii) frequent-error statistics for the cluster; and causing display of the cluster-level outputs.

16. The non-transitory computer-readable medium of claim 15, wherein generating feature vectors comprises applying TF-IDF to the normalized text.

17. The non-transitory computer-readable medium of claim 15, wherein initializing clustering centroids comprises adjusting a selected index by incrementing or decrementing the selected index responsive to a quantum-derived random bit, and applying modulo arithmetic to keep the selected index within bounds.

18. The non-transitory computer-readable medium of claim 15, wherein clustering comprises performing K-means clustering with an initialization that uses the initialized clustering centroids and with a single initialization run.

19. The non-transitory computer-readable medium of claim 15, wherein producing cluster-level outputs comprises computing, for each cluster, a count of log entries mapped to the cluster and outputting a plot of counts across clusters.

20. The non-transitory computer-readable medium of claim 15, wherein receiving log entries comprises continuously ingesting streaming log entries, and wherein the operations further comprise periodically re-clustering based on newly ingested streaming log entries.
